(19) United States
(12) Patent Application Publication
(10) Pub. No.: US 2007/0066288 A1
(43) Pub. Date: Mar. 22, 2007

(54) System and method for sharing a personal contact directory

(75) Inventors: Emily Lyons Soelberg, Atlanta, GA (US); Jeffrey Mikan, Cumming, GA (US)

Correspondence Address: GARDNER GROFF SANTOS & GREENWALD, P.C., 2018 POWERS FERRY ROAD, SUITE 800, ATLANTA, GA, 30339, US

(73) Assignee: Cingular Wireless, II, LLC

(21) Appl. No.: 11/230,124

(22) Filed: Sep. 19, 2005

(51) Int. Cl. H04M 3/42

(52) U.S. Cl. 455/415

(57) ABSTRACT

A mobile communications network system includes a centralized data storage device and a plurality of wireless communication devices, wherein the centralized data storage device stores a personal contact directory of a first user that can be accessed by a second user. Preferably, the mobile communications network system further comprises a user verification module for granting access to the second user if the first user previously authorized the second user to have such access. The user verification module can authorize a user by verifying a unique identifier of the wireless communication device or a password inputted by a user.

### BACKGROUND OF THE INVENTION

1. Field of the Invention

The present invention relates generally to the field of wireless communications systems, and more particularly to a system and method for sharing a user's personal contact directory.

2. Description of the Related Art

Many users of cellular telephones prefer to store important phone numbers or frequently called phone numbers in personal contact directories in their cellular phones. However, if the cellular phone is lost or stolen, the personal contact directory is also lost, as the personal contact directory is typically stored in the device itself or in the phone's SIM card. Thus, in order to re-create the personal contact directory in the new phone, the user typically would manually re-input the contents of his or her previous personal contact directory into the new phone, a process that can be somewhat time-consuming and cumbersome.

In other instances, a person may wish to gain access to another user's personal contact directory or a portion of another user's personal contact directory. For example, one user, such as a husband, may want to access the personal contact directory of his wife. In such instances, the person would have to use the other's phone to manually look up the desired phone number stored in that phone, or the person's personal contact directory would have to be synched with the that of the other person's phone. Unfortunately, this requires physical proximity to the second phone, which is not always possible or practical.

Currently, some corporations have a global contact list for those in the organization to access. The list is a large, shared directory that enables users to lookup a contact in the list (typically a phone number). However, the list is a single list of contacts typically limited to contacts within the corporation. The global contact list does not provide employees a way to store their personal contacts in a separate directory, which could later be shared with other employees.

Therefore, a need yet exists within the industry for a wireless communication system and methods for selectively permitting someone to access another user's personal contact directory. It is to the provision of such a system and method that the present invention is primarily directed.

### SUMMARY OF THE INVENTION

Briefly described, in one form the present invention is a method of operating a wireless communications network of the type having multiple users of wireless communication devices. The method includes the steps of storing a contact directory for a first user in a network-based storage device and granting a second user access to the first user's contact directory. Preferably, the step of granting a second user access is conditioned upon the first user having previously authorized the second user to have such access. Examples of authorizing the second user include authorizing the second user based upon a password or approving the second user based on a unique identifier identifying the second user or the second user's wireless device. The access granted to the second user can be limited to “read only” or can be read and write access. Also preferably, the method includes the steps of allowing the second user to synch his or her contact directory with the contact directory of the first user and allowing the second user to download the contact directory to his or her wireless communication device. Upon access being granted to the second user, the second user can search the database for a specific entry in the contact directory.

According to an exemplary embodiment, the present invention includes a mobile communications network system that has a centralized data storage device and a plurality of wireless communication devices, wherein the centralized data storage device stores a personal contact directory of a first user that can be accessed by a second user. Preferably, the wireless communications device is a mobile phone. Also preferably, the mobile communications network includes a user verification module for granting access to the second user if the first user authorized the second user to have such access. The user verification module can grant access to the first user's personal contact directory by verifying a unique identifier of the wireless communication device, such as a mobile phone number of the mobile phone, a serial number of the mobile phone, or a SIM number of the mobile phone. Alternatively, the user verification module can verify a password inputted by a user and then grant access to the personal contact directory. The access granted can be limited to read only, or the access granted can be read/write. Preferably, the personal contact directory can be searched for a particular entry. Also preferably, the second user can directly initiate a communication with the contact directly from the personal contact directory once a particular entry is located.

Advantageously, the present invention allows a peer-to-peer sharing of contact information. An owner of a personal contact directory can share his or her personal contact directory with other users of the system automatically without the need for one user to contact the owner of the directory (who has the desired information) directly for that contact information. Also, owners of personal contact directories can specify which other users of the system can have access to their directory or just a portion of the directory. Thus, the owners of the directories can prevent his or her directory from being made public to all users of the system. Users can search others' directories for a particular entry, and once the entry is found, the user can press a single button or a series of buttons to initiate a communication with the person or entity associated with that particular entry. Such communication can include a phone call, an email, or short text message. Owners can also specify if the users have read access only or read and write access. With read access, users can download or synch the personal directory to his or her wireless communications device. With read and write access, users can additionally upload information to the owner's personal contact directory.

Other advantages and benefits of the present invention will become apparent upon reading and understanding the present specification when taken in conjunction with the appended drawings.

### BRIEF DESCRIPTION OF THE DRAWINGS

FIG. 1 is a system diagram of a mobile communications system according to an exemplary embodiment of the present invention.

FIG. 2 is a flowchart representation of a method for determining an authorized user and granting access to the authorized user of the system of FIG. 1.

### DETAILED DESCRIPTION OF THE INVENTION

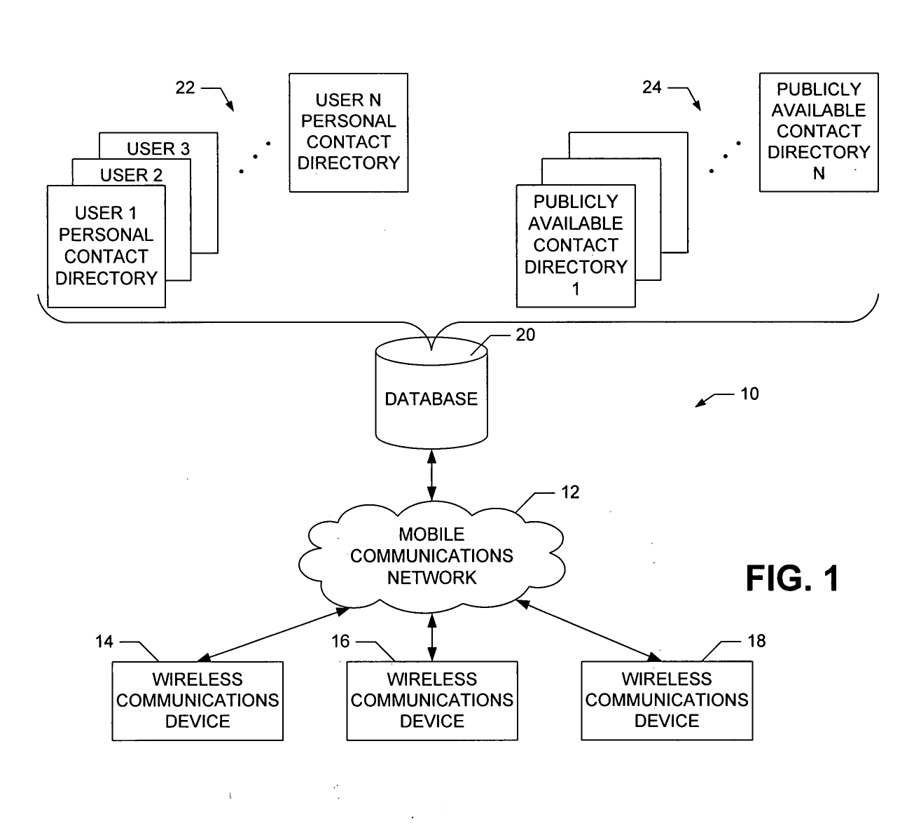

Referring now to the drawings in which like numerals represent like elements or steps throughout the several views, FIG. 1 displays a system diagram of a mobile communications system 10 according to an exemplary embodiment of the present invention. The system 10 includes a mobile communications network 12, and such mobile communications networks are generally well known in the art. A plurality of wireless communications devices 14, 16, and 18, each associated with a particular user of the system 10, connect to the mobile communications network 12. Although FIG. 1 depicts three such wireless communications devices for ease of description, those skilled in the art will understand that any number of wireless communications devices, typically thousands or millions, can connect to the mobile telecommunications network. Preferably, the wireless communications device is a mobile phone; however, other exemplary wireless communications devices that can be employed as well include PDA's, pagers, or other such wireless devices for communicating with another. Preferably, the wireless communications device has a user interface so that the user can access the mobile communications network 12 via the wireless communications device.

A database or other data storage device 20 can be connected to or reside on the mobile telecommunications network 12. The database 20 is operable to store one or more personal or private contact directories 22 and/or one or more publicly available contact directories 24. Additionally, the database 20 can also store other personal information, such as one's calendar, tasks, notes, or other information. Preferably, the publicly available contact directories 24 are made available to all users of the system 10. Preferably, each personal or private contact directory 22 has an “owner” associated with it who owns the directory. In other words, the owner has full read and write access to his or her own contact directory and determines which other users, if any, have access to his or her personal contact directory or a portion thereof. The owner of the personal contact directory 22 can be any person or entity. The personal or private contact directories 22 can include a list of contacts (such as persons or entities), including one or more of the following contact information: the contact's home and/or work phone numbers, mobile phone numbers, email addresses, instant messaging user names, physical mailing addresses, pager information, or any other information that can be used to contact a person or entity. The personal contact directories 22 can include one or more sub-directories such as various work groups, family groups, friends groups, or other such sub-directories or groups of contacts that preferably can be grouped together based on a commonality.

Preferably, the personal contact directories 22 are protected such that only the owner and those users authorized by the owner of the personal contact directory can have access, whether read only or read and write, to the personal contact directory. Preferably, the owner has full read and write access to his or her own personal contact directory. However, preferably, when the owner grants read and write access to a particular user, that particular user does not have the option of authorizing or unauthorizing other users. Thus, the read and write access granted to users other than the owner may not be full read and write access (although full read and write access could be granted as well).

Thus, to authorize or verify a particular user, the system 10 can include a user verification or user authorization module for determining which users have access to particular contact directories, or portions thereof, and granting access to those authorized. The owner can access the user verification module and preauthorize users by granting access or permission to the personal contact directory 22 or to a portion of the directory, such as for example, to a specific subdirectory. The access granted can be read only or read and write. The owner can preauthorize a user in a number of ways. For example, the owner can use a web-based interface to set and store a password, which can access the personal contact directory 22, and then give the password to the authorized users so that they can input the password to access the directory. Alternatively or additionally, the owner can authorize wireless communication devices based on a unique identifier, such as a phone number of a wireless communication device if the device is a phone, a serial number of the wireless communications device, a SIM number of the wireless communications device, or any other unique number associated with the wireless communications device or with the user of the wireless communications device. Or, a user can send a query to the system 10 to access the owner's contact directory, and if the user is not preauthorized, then the system can send a notification to the owner asking if user is permitted to access the system. At that point, the owner can authorize the user.

The owner of the personal contact directory 22 can authorize users and grant specific access to each user on an individual basis. As an example, the personal contact directory 22 can include subdirectories A, B, and C. The owner of the personal contact directory 22, who has full read and write access, can authorize User 1 to have read and write access to the entire directory, while User 2 has read access only to subdirectories A and B and while User 3 has read access to subdirectory A and read and write access to subdirectory C. Additionally, it should be noted that in exemplary embodiments, the owner of the personal contact directory 22 also has the option of later revoking some or all of the permissions for all or some of authorized users.

When a user is granted access to a particular personal contact directory, the user can have option of downloading or synching the contact information from the database with his or her wireless communications device. Thus, the information about the contacts stored on the database 20 can be used to update or add to existing contact information stored in the user's wireless communications device. Additionally, the owner's personal contact directory stored on the network can be a separate directory from the user's directory stored locally on the wireless communications device. Alternatively in another embodiment, the personal contact directory 22 can automatically synch with the wireless communication device when the device accesses the personal contact directory. Those skilled in the art will understand that there are various ways to synch a wireless communications device with a personal contact directory, all of which can be employed without deviating from the scope of the present invention. One such known standard is SyncML. Moreover, when the personal contact directory is automatically synched with the wireless communications device, an expiration timer can be added to the existing SyncML so that after the expiration date, the system 10 will force the user to resynchronize the owner's personal contact directory if the user tries to access the directory on his or her wireless communications device. If the owner of the personal contact directory 22 revokes the user's authorization, then when the wireless device attempts to resynch with the network, the system 10 can delete the owner's personal contact directory from the user's wireless device. The benefit of synching the contact directory 22 with the wireless communications device is that the user can access frequently used contact information more quickly than searching the database 20 on the network 12.

When a user has read and write access to a particular personal contact directory, or a portion thereof, the user can additionally upload new contact information or can update contact information to the owner's personal contact directory. Owners of personal contact directories can have the option of storing a mirror image of their directories on their wireless devices, thus synching their wireless communications device with the directory stored on the network 12, or owners can store the directories solely on the mobile communications network.

Preferably, the personal contact directory can be searched for a particular entry. The entries can be listed alphabetically, and the user can scroll through the entries until the one desired is found. Alternatively, the user can begin typing in the letters of the person's name until the desired entry appears on the screen of the wireless device. Once the desired entry is located, the user can press a single button or a series of buttons to initiate a communication with the person or entity associated with the entry. Thus, preferably, the user can initiate a communication directly from the owner's personal contact directory 22 (i.e., without the need for typing, for example, in the phone number, email, or instant messaging user name. For example, by pressing a SEND button, the user can automatically initiate a phone call. Or, the SEND button can be used to activate an instant message session. Or, the SEND button can be used to open a blank email message so that the user can type a message therein and send to the contact.

Similarly, the publicly available contact directories 24 can be searched for a particular entry. With the publicly available contact directories 24, no authorization is needed, as the publicly available contact directories 24 include information that is publicly available, such as from telephone directories. Preferably, there are a series of publicly available contact directories 24 that are sorted in a logical manner, such as by location (e.g., by city, county, or state) or by kind (e.g., residential or business), or any combination thereof. The user can sort through or search the series the publicly available directories 24 for an appropriate directory, and then locate a contact in a manner similar to locating a contact in the personal contact directories 22. Those skilled in the art will understand that there are various ways to configure, store, and search the directories on the data storage device 20, all of which can be employed without deviating from the scope of the present invention.

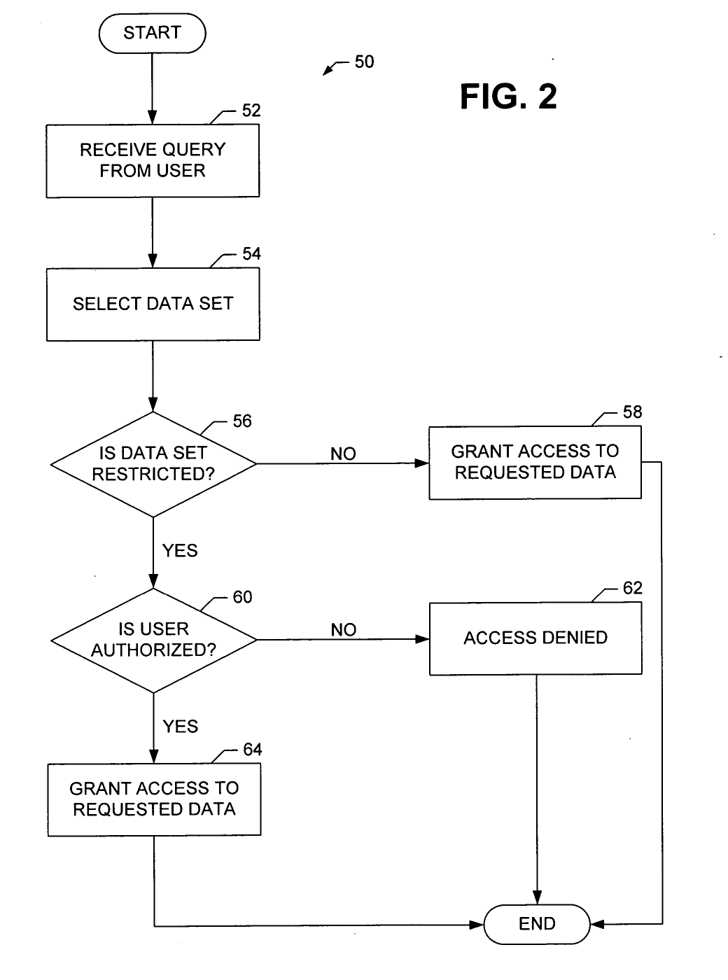

In operation, a method 50 for determining an authorized user and granting access to the authorized user to personal contact directories is depicted in FIG. 2. Beginning at step 52, the system 10 receives a query from a user to access a particular contact directory. At step 54, the system 10 selects the data set from the publicly available contact directories or from the personal contact directories. At step 56, the system 10 determines whether the not the data set is restricted. If the data set is not restricted, as is the case of publicly available contact directories, the system 10 grants the user access to the requested data at step 58, and the method 50 ends.

However, if the data set is restricted, as is the case of personal contact directories, the system 10 then determines if the user is an authorized user at step 60. If the system 10 determines that the user is not an authorized user, the system 10 denies access to the user, and the method 50 ends. But if the system determines that the user is an authorized user, then the system 10 grants access to the requested data. Optionally, the user can synch the personal contact directory 22 with his or her wireless communications device.

Whereas this invention has been described in detail with particular reference to exemplary embodiments and variations thereof, it is understood that other variations and modifications can be effected within the scope and spirit of the invention, as described herein before and as defined in the appended claims.

What is claimed is:

1. A method of operating a wireless communications network of the type having multiple users of wireless communication devices, the method comprising the steps of:
storing a contact directory for a first user in a network-based storage device; and
granting a second user access to the first user's contact directory.

2. The method of claim 1, wherein the step of granting a second user access is conditioned upon the first user having authorized the second user to have such access.

3. The method of claim 2, wherein the second user's access is approved based on a unique identifier identifying the second user or the second user's wireless device.

4. The method of claim 3, wherein the wireless device is a mobile phone and the unique identifier is the mobile phone number of the mobile phone.

5. The method of claim 2, wherein the second user's access is password protected.

6. The method of claim 1, further comprising allowing the second user to synch his or her contact directory with the contact directory of the first user.

7. The method of claim 1, further comprising allowing the second user to download the contact directory to his or her wireless communication device.

8. The method of claim 1, further comprising the step of querying the database for a specific entry in the personal contact directory.

9. The method of claim 1, wherein the access granted to the second user is limited to read only.

10. The method of claim 1, wherein the access granted to the second user is read and write access.

11. A mobile communications network system, comprising:
a plurality of wireless communication devices; and
a centralized data storage device, wherein the centralized data storage device stores a personal contact directory of a first user that can be accessed by a second user.

12. The system of claim 11, wherein the mobile communications network system further comprises a user verification module for granting access to the second user if the first user authorized the second user to have such access.

13. The system of claim 12, wherein the user verification module verifies a unique identifier of the wireless communication device.

14. The system of claim 13, wherein the wireless communication device is a mobile phone and the unique identifier is one of a mobile phone number of the mobile phone, a serial number of the mobile phone, or a SIM number of the mobile phone.

15. The system of claim 12, wherein the user verification module verifies a password inputted by a user and permits access to the personal contact directory if the inputted password is verified.

16. The system of claim 12, wherein the access granted is limited to read only.

17. The system of claim 12, wherein the access granted is read and write access such that the second user can upload contact information to the first user's personal contact directory.

18. The system of claim 11, wherein the personal contact directory can be queried for a particular entry.

19. The system of claim 18, wherein once a particular entry is located, the second user can directly initiate a communication with the contact.

20. The system of claim 11, wherein at least a portion of the first user's personal contact directory can be synched with a wireless communication device of the second user.
